(19) United States
(12) Patent Application Publication
(10) Pub. No.: US 2007/0091072 A1
(43) Pub. Date: Apr. 26, 2007

(54) Method for inputting words in an electronic appliance with buttons of inputting words

(76) Inventor: Ik Soo Eun, Seoul (KR)

Correspondence Address: ROBERTS, MLOTKOWSKI & HOBBES, P. O. BOX 10064, MCLEAN, VA, 22102-8064, US

(21) Appl. No.: 11/272,808

(22) Filed: Nov. 15, 2005

(30) Foreign Application Priority Data
Oct. 21, 2005 (WO) PCT/KR05/03525

(51) Int. Cl. G09G 5/00

(52) U.S. Cl. 345/169

(57) ABSTRACT

Disclosed is a method of inputting a character in mobile devices. A simultaneous pressing, an overlapped-pressing, a long-and-short continuous pressing of two buttons, and a double-click of one button are employed to input as many letters as possible in a fast and convenient mode using a limited number of buttons, thereby improving use of buttons. In the input buttons of mobile devices, each button is assigned with one character and at least one character is assigned to between two neighboring buttons, such that the assigned letters can be input through a simultaneous pressing, an overlapped-pressing, or a long-and-short continuous pressing of two neighboring buttons.

### TECHNICAL FIELD

The present invention relates to a method of inputting a character using a button in an electronic device such as electrical telephones, cellular phones, PDAs or the like. More specifically, the invention relates to a method of inputting a character in an electronic device having character-input buttons, in which characters having a high frequency of use is assigned to each button so as to be input through a single click of one button, and the remaining characters are configured to be input through a simultaneous pressing, an overlapped-pressing, or a long-and-short continuous pressing of neighboring two buttons, thereby shortening input time and enabling easy and convenient input of characters.

### BACKGROUND ART

Recently, as electronic and communication technologies have been significantly advanced, a character input function is required in order to control electronic devices. In particular, as mobile devices such as PDAs and cellular phones have been increasingly popularized, use of letter message has been drastically increased and simultaneously a remote control of external devices through a character input from a cellular phone, i.e., a home-care service has been attempted.

In order to improve these character-input techniques, terminal manufacturers such as Samsung electronics, Inc., LG Electronics, Inc., Nokia, and Motorola have developed and applied their own character-input technologies.

As shown in FIG. 1, input buttons of cellular phones manufactured by the above manufacturers, each button is sequentially assigned with three or four alphabets. In order to input English letters, each button must be pressed one to four times, thereby leading to a significant increase in the number of input strokes and thus degrading efficiency of input. As described above, in the case where one button is assigned with at least 3 alphabets and the assigned alphabets are input in a cyclic fashion, when alphabets assigned to a same button is intended to input in sequence, a certain period of time must be held or a fixing button must be pressed until a selected alphabet is fixed. Therefore, it results in unnecessary time consumption and also unnecessary additional pressing of buttons. In addition, in the conventional system, if even symbols, together with alphabets, are assigned to the buttons, the number of button-pressings reaches above three times, thereby degrading efficiency in inputting of both symbols and alphabets. Thus, it is not easy to assign symbols to buttons. Accordingly, symbols are input typically through a menu mode, where each symbol must be selected one by one, thereby leading to tardy and inconvenient input of symbols.

### DISCLOSURE OF INVENTION

### Technical Problem

Accordingly, the present invention has been made in order to solve the above problems in the prior art, and it is an object of the invention to provide a method of inputting a character in an electronic device having character-input buttons, in which a double-click of one button, and a simultaneous pressing, an overlapped-pressing or a long-and-short continuous pressing of two buttons are employed to thereby shorten the number of input strokes and the input time and improve the mobility of fingers and visibility.

Another object of the invention is to provide a method of inputting English letters in an electronic device having character-input buttons, in which at least nine buttons among twelve buttons are assigned with one alphabet respectively and the remaining alphabets are configured to be input through a simultaneous pressing, an overlapped-pressing or a long-and-short continuous pressing of two neighboring buttons, thereby enabling fast and convenient input of most English letters.

A further object of the invention is to provide a method of inputting English letters in an electronic device having character-input buttons, in which basic alphabets are assigned to each button, and the remaining letters are formed through a double-click of buttons assigned with basic alphabets and combinations of two basic alphabets, such that English letters can be easily learned and input fast through a simultaneous pressing, an overlapped-pressing, or a long-and-short continuous pressing of two buttons.

### Technical Solution

In order to accomplish the above object, according to a first aspect of the invention, there is provided a method of inputting a character in an electronic device having a character input button, wherein a character is assigned to each button of a keypad of the electronic device, and at least one character is assigned to between neighboring two buttons such that the neighboring two buttons are simultaneously pressed, overlapped-pressed, or continuously pressed in a longer and shorter pattern to input the at least one character assigned in-between.

According to a second aspect of the invention, there is provided a method of inputting English letters in an electronic device having a character input button arranged in rows and columns, wherein English letters ‘T’, ‘I’, ‘N’, ‘E’, ‘R’, ‘S’, ‘O’ and ‘L’ are assigned to nine buttons respectively, the remaining letters are assigned to between two neighboring buttons in horizontal, vertical and diagonal directions, such that the simultaneous pressing, the overlapped-pressing, or the long-and-short continuous pressing of the two neighboring buttons inputs the corresponding letter assigned in-between.

According to a third aspect of the invention, there is provided a method of inputting English letters in an electronic device having a character input button arranged in rows and columns, wherein nine basic letters 0, −, [symbol] , I, [symbol] , J, M, ˆ, and E are assigned to the respective buttons, letters O, X, I, C, J, M, A, and E are input by pressing each button once, and the remaining letters are input through an overlapped-pressing or a long-and-short continuous pressing of two buttons assigned with the basic letters, or through a double-click of one button.

According to a fourth aspect of the invention, there is provided a method of inputting English letters in an electronic device having a character input button arranged in rows and columns, wherein nine basic letters 0, −, [symbol] , I, [symbol] , J, M, ˆ, and F are assigned to the respective buttons, letters O, X, I, C, J, M, A, and F are input by pressing each button once, and the remaining letters are input through an overlapped-pressing or a long-and-short continuous pressing of two buttons assigned with the basic letters, or through a double-click of one button.

### Advantageous Effects

As described above, according to the present invention, the button input employs a simultaneous pressing, an overlapped-pressing and a long-and-short continuous pressing of two buttons so that the use of buttons is improved to thereby assign as many characters as possible to a limited number of buttons. In particular, in the case of inputting English letters, the concept of the above double-click, simultaneous pressing, overlapped-pressing, long-and-short continuous pressing is applied in horizontal, vertical or diagonal direction. Thus, two adjacent buttons in horizontal, vertical and diagonal directions can be pressed in the above modes to input one alphabet no more than two pressings. Alphabets having a high frequency of use can be input through a single pressing. Therefore, a fast, simple and convenient input of English letters is achieved through a significant reduction in the number of input strokes, as compared with the conventional method where at least three alphabets are assigned to one button and input in a cyclic mode. Furthermore, an order concept is introduced into the above overlapped-pressing and long-and-short continuous pressing so that numerous letters can be input through a less number of buttons and input strokes.

In addition, no more than ten basic letters are selected from English alphabets and assigned to the respective buttons. Two buttons among the basic letters are combined through an overlapped-pressing or a long-and-short continuous pressing to thereby generate all the alphabet letters. Thus, English buttons of a cellular phone can be easily learned and thus easily used by everyone. Furthermore, letters having a high frequency of use are assigned to the respective buttons and can be input by a single input stroke. According to the frequency of use, the letters are assigned sequentially from easily accessible buttons towards outer buttons, thereby facilitating fast and convenient input of English letters. Thus, as English has been widely used through frequent exchange with foreigners, the efficiency of exchange can be improved through a reduction in the input strokes. Furthermore, the vacant positions of each button (beyond the second position) are assigned with symbols, which can be input through continuous double-click in a cyclic fashion, thereby significantly improving easy input of symbols.

### DESCRIPTION OF THE DRAWINGS

Further objects and advantages of the invention can be more fully understood from the following detailed description taken in conjunction with the accompanying drawings in which:

FIG. 1 shows a button arrangement for inputting English letters in a common cellular phone;

FIG. 2 explains a method of inputting a character in an electronic device according to an embodiment of the invention;

FIG. 3 illustrates a button arrangement of a cellular phone for inputting English letters according to the character-input principle of FIG. 2;

FIG. 4 illustrates a variation of the button arrangement of FIG. 3 where the position of buttons is modified;

FIG. 5 explains a character-input method according to another embodiment of the invention;

FIG. 6 explains a character-input method according to yet another embodiment of the invention; and

FIGS. 7 and 8 shows a modification of the embodiment illustrated in FIG. 6.

### BEST MODE FOR INVENTION

The present invention employs a simultaneous pressing, an overlapped-pressing and a long-and-short continuous pressing of two buttons such that as many characters as possible can be assigned to a limited number of buttons, thereby enabling to easily input characters with a less number of input strokes. In particular, these combined pressing modes of two buttons are applied in horizontal, vertical and diagonal directions so that more letters can be input through a single pressing of buttons.

The preferred embodiments of the invention will be hereafter described in detail with reference to the accompanying drawings.

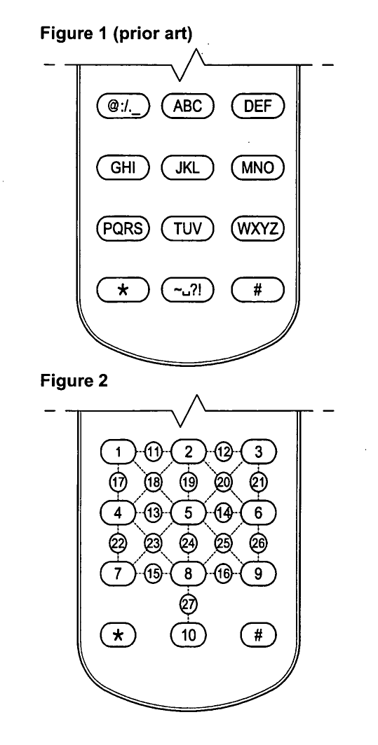

FIG. 2 explains a method of inputting a character in an electronic device according to an embodiment of the invention. Here, the electronic device means all electronic devices having character input buttons and capable of inputting characters thereto. In particular, the electronic device includes electronic communication devices such as cellular phones or PDAs where a communication technology is applied, and portable electronic devices such as digital cameras to which a wireless communication technology may be applied in the future. The character-input method of the invention is applicable to the function control of electronic devices through inputting of characters, transmission of a letter message in communication devices, and the like. Hereinafter, the present invention will be explained, illustrating a cellular phone as an electronic device having character input buttons. The principles of the present invention can be applied to all the electronic devices capable of inputting characters. In the figures, two neighboring buttons in horizontal, vertical and diagonal directions are depicted as being connected to each other by a dot line.

In FIG. 2, twelve buttons are arranged, where ten numeral buttons of 1 to 10 are assigned with a character respectively and also a character is assigned between neighboring two buttons, which are pressed in combinations to input a character. At this time, the combinations of two adjacent buttons include simultaneous pressing of two buttons, overlapped pressing of two buttons, or consecutive pressing of two buttons where one button is pressed longer and the other one is pressed shorter. Here, the neighboring two buttons may be two buttons adjacent in horizontal direction, for example numeral buttons of 1 and 2, two buttons adjacent in vertical direction, for example numeral buttons of 1 and 4, or two buttons in diagonal direction, for example numeral buttons of 1 and 5.

Practically, it is unlike that two buttons are pressed exactly at the same time. Thus, a time interval is established such that a controller of an electronic device can determine as a simultaneous pressing when two buttons are pressed within the established time interval. For example, after pressing a first button, if a second button is pressed within 0.15˜0.2 sec, the two buttons are recognized as a simultaneous pressing. Furthermore, in a case where a simultaneous pressing mode is adopted, when a second button is pressed while pressing a first button, a character assigned to the first button is displayed and simultaneously a character assigned to the combination of the first and second buttons is displayed, thereby improving the speed and efficiency of inputting characters.

Referring to FIG. 2, a simultaneous pressing mode is explained. For example, when the buttons of 1 and 2 horizontally adjacent are simultaneously pressed by means of two hands (otherwise, overlap-pressed, or one button is pressed longer and the other one shorter), a character corresponding to the number 11 is input. When the buttons of 8 and 9 are pressed, a character assigned to the number 16 is input. In addition, if the buttons of 4 and 7 vertically adjacent are simultaneously pressed, a character corresponding to the number 22 is input. When the buttons of 2 and 4 diagonally adjacent are simultaneously pressed, a character assigned to the number 18 is input. The same principle is applied to the remaining combination of neighboring buttons. That is, two buttons, horizontally, vertically or diagonally adjacent to each other, are pressed to input a character assigned to between them.

In FIG. 2, characters corresponding to combined inputs of neighboring buttons are discernibly expressed at the middle of horizontal, vertical and diagonal connection lines between the two buttons. As shown in FIG. 2, the characters assigned to combinations of adjacent buttons are expressed as numbers of from 11 to 27.

Furthermore, each button is assigned with one character, but according to the present invention, each button may be further assigned with symbols (for example, “.” “,” “−” “+” “ˆ” “˜” etc.) in such a manner that these symbols are input by a double click in a cyclic passion. The double click is performed in the same manner as in the mouse of a computer, i.e., by pressing a button twice in a fast mode.

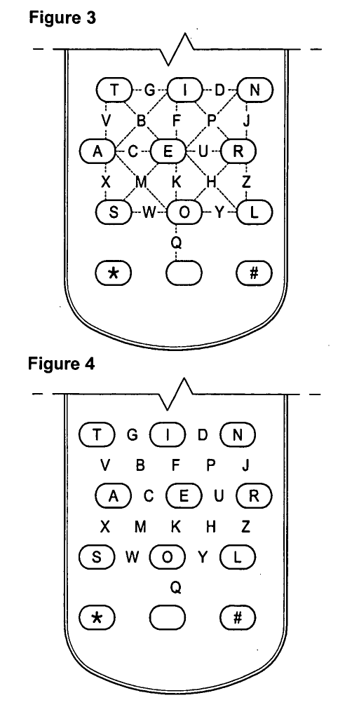

FIG. 3 illustrates a button arrangement of a cellular phone for inputting English letters according to the character-input principle of FIG. 2. FIG. 4 illustrates a variation of the button arrangement of FIG. 3 where the position of buttons is modified.

English letter can be easily input according to the character-input principle as described in conjunction with FIG. 2. Referring to FIG. 3, English letter input will be explained in detail.

Nine basic letters are selected from English alphabets and these basic letters are assigned respectively to nine of twelve buttons. Selection of the basic letters is preformed, considering use frequency of each English letter. It is preferable to select nine letters having the highest frequencies of use. Thus, in this embodiment, the use frequency of each English letter is searched from an English dictionary (Concise Oxford Dictionary, 9^{th} edition, 1995). The search result is summarized in Table 1, based on which nine letters are selected from the first to ninth frequency of use. The higher frequency letters are assigned to central buttons and the lower frequency ones are assigned to outward buttons.

TABLE 1
Use frequency of each English letter from Oxford Dictionary

| English letter | Frequency of use | English letter | Frequency of use |
|---|---|---|---|
| E | 11.1607% | M | 3.0129% |
| A | 8.4966% | H | 3.0034% |
| R | 7.5809% | G | 2.4705% |
| I | 7.5448% | B | 2.0720% |
| O | 7.1635% | F | 1.8121% |
| T | 6.9509% | Y | 1.7779% |
| N | 6.6544% | W | 1.2899% |
| S | 5.7351% | K | 1.1016% |
| L | 5.4893% | V | 1.0074% |
| C | 4.5388% | X | 0.2902% |
| U | 3.6308% | Z | 0.2722% |
| D | 3.3844% | J | 0.1965% |
| P | 3.1671% | Q | 0.1962% |

Nine letters E, A, R, I, O, T, N, S and L having higher frequency of use are selected as the basic letters from Table 1. The basic letters can be input as follows. The letters T, I and N are assigned to the buttons of number 1, 2 and 3 respectively on the first row. The letters A, E and R are assigned to the buttons of number 4, 5 and 6 respectively on the second row, and the letters S, O and L are assigned to the buttons of number 7, 8 and 9 respectively on the third row. In this way, the nine letters, which are assigned to the buttons of number 1 to 9, can be input by pressing each corresponding button once.

With respect to combination input of horizontal direction, the letter G and D are assigned respectively to the positions of number 11 and 12 between the number 1 and 2 buttons and between the number 2 and 3 buttons on the first row. Thus, pressing the number 1 and 2 buttons horizontally adjacent inputs the letter G assigned in-between. Pressing the number 2 and 3 buttons inputs the letter D assigned in-between. In addition, the letter C and U are assigned respectively to between the number 4 and 5 buttons and between the number 5 and 6 buttons on the second row. Thus, pressing the number 4 and 5 buttons inputs the letter C assigned in-between. Pressing the number 5 and 6 buttons inputs the letter U assigned in-between. As shown in FIGS. 3 and 4, the letter W and Y are assigned and input in the same way as above.

With respect to combination input of horizontal direction, the letter V and X are assigned to the positions of number 17 and 22 respectively between the number 1 and 4 buttons and between the number 4 and 7 buttons on the first column. Thus, pressing the number 1 and 4 buttons vertically adjacent inputs the letter V assigned in-between. Pressing the number 4 and 7 buttons inputs the letter X assigned in-between. Similarly, in case of the letters F, K and Q on the second column and the letters J and Z, buttons vertically adjacent to each corresponding letter can be pressed to input the respective letters.

With respect to combination input of diagonal direction, in the case of the letter B assigned in the middle of the diagonal line between two adjacent buttons, pressing the number 1 and 5 buttons or the number 2 and 4 buttons inputs the letter B assigned in-between. Similarly, the letters P, M and H assigned in the middle of a diagonal line between two adjacent buttons can be input in the same manner as above.

In the button arrangement of FIG. 3, adjacent rows are a little offset from each other. Therefore, when pressing two buttons simultaneously or overlapped-pressing a button, a space for convenient pressing is provided such that two fingers are not collided with each other. In FIG. 4, adjacent button rows are offset in opposite direction to FIG. 3 and thus a space for fingers is provided. The same principle of the invention is applied to the buttons of FIGS. 3 and 4, except for a little displacement of buttons.

Hereinafter, English letter input method according to the invention will be explained, in comparison to a conventional English input method, referring to examples of inputting English sentences.

### EXAMPLE 1 OF ENGLISH LETTER INPUT

According to the English letter input method of the invention, input of the following sentence will be illustrated using the keypad of a cellular phone.

With respect to the English sentence “CELLULAR PHONE IS A BLACK HOLE OF ALL THE FUNCTIONS OF MOBILE UTILITIES.”, the number of input strokes will be compared for the conventional input method as described in conjunction to FIG. 1 and an input method according to the present invention. Here, the space is not counted as an input stroke. Hereafter, the number in parenthesis following each English letter denotes the number of input stokes for inputting each corresponding letter.

1. In Case of a Conventional Input

‘C(3)+E(2)+L(3)+L(3)+U(2)+L(3)+A(1)+R(2)’+‘P(1)+H(2)+O(3)+N(2)+E(2)’+‘I(3)+S(3)’+‘A(1)’+‘B(2)+L(3)+A(1)+C(3)+K(2)’+‘H(2)+O(3)+L(3)+E(2)’+‘O(3)+F(3)’+‘A(1)+L(3)+L(3)’+‘T(1)+H(2)+E(2)’+‘F(3)+U(2)+N(2)+C(3)+T(1)+I(3)+O(3)+N(2)+S(3)’+‘O(3)+F(3)’+‘M(1)+O(3)+B(2)+I(3)+L(3)+E(2)’+‘U(2)+T(1)+I(3)+L(3)+I(3)+T(1)+I(3)+E(2)+S(3)’

[symbol] 138 (letter input)+7 (fixing button)=145 strokes in total

In the above input, a fixing button must be pressed between the underlined letters in order to confirm and fix the preceding letter before inputting the following letter. Thus, the input stroke for the fixing button is added.

2. In Case of the Present Invention

Continuous pressings of longer and shorter strokes are counted as two strokes.

‘C(2)+E(1)+L(1)+L(1)+U(2)+L(1)+A(1)+R(1)’+‘P(2)+H(2)+O(1)+N(1)+E(1)’+‘I(1)+S(1)’+‘A(1)’+‘B(2)+L(1)+A(1)+C(2)+K(2)’+‘H(2)+O(1)+L(1)+E(1)’+‘O(1)+F(2)’+‘A(1)+L(1)+L(1)’+‘T(2)+H(2)+E(1)’+‘F(2)+U(2)+N(1)+C(2)+T(1)+I(1)+O(1)+N(1)+S(1)’+‘O(2)+F(2)’+‘M(2)+O(1)+B(2)+I(1)+L(1)+E(1)’+‘U(2)+T(1)+I(1)+L(1)+I(1)+T(1)+I(1)+E(1)+S(1)’

[symbol] 78 strokes in total

Simultaneous pressings are counted as one stroke.

‘C(1)+E(1)+L(1)+L(1)+U(1)+L(1)+A(1)+R(1)’+‘P(1)+H(1)+O(1)+N(1)+E(1)’+‘I(1)+S(1)’+‘A(1)’+‘B(1)+L(1)+A(1)+C(1)+K(1)’+‘H(1)+O(1)+L(1)+E(1)’+‘O(1)+F(1)’+‘A(1)+L(1)+L(1)’+‘T(1)+H(1)+E(1)’+‘F(1)+U(1)+N(1)+C(1)+T(1)+I(1)+O(1)+N(1)+S(1)’+‘O(1)+F(1)’+‘M(1)+O(1)+B(1)+I(1)+L(1)+E(1)’+‘U(1)+T(1)+I(1)+L(1)+I(1)+T(1)+I(1)+E(1)+S(1)’

[symbol] 59 strokes in total

As can be seen in the above letter input example one, as many as 145 strokes are required in case of the conventional input method. In contrast, according to the present invention, 78 strokes are needed in the case of the continuous pressing mode. In the case of the simultaneous pressing, only 59 strokes are required for inputting the same sentence. In the present invention, in the case of the overlapped pressing mode, when an overlapped-pressing of two buttons is counted as two strokes, the same strokes as in the long-and-short continuous pressing are required. Furthermore, in the conventional input method, when letters assigned to the same button are input, a previous letter must be confirmed by pressing a fixing button before inputting a following button. Thus, unnecessary pressing of the fixing button is required. In the present invention, however, since a single letter is assigned to one button, the pressing of a fixing button is not required, thereby efficiently avoiding unnecessary additional pressing of buttons.

As can be seen through the above letter input example, the English letter input method of the invention is faster than the conventional one, in all cases of the simultaneous pressing, overlapped pressing and long-and-short continuous pressing modes.

### EXAMPLE 2 OF ENGLISH LETTER INPUT

The English letter input method of the invention and the conventional English input method are compared in a case of inputting of the word “INTERNATIONAL.”

1. In Case of a Conventional Input

I(3)+N(2)+T(1)+E(2)+R(3)+N(2)+A(1)+T(1)+I(3)+O(3)+N(2)+A(1)+L(3)

[symbol] 27 (letter input)+1 (fixing button)=28 strokes in total

2. In Case of the Present Invention

I(1)+N(1)+T(1)+E(1)+R(1)+N(1)+A(1)+T(1)+I(1)+O(1)+N(1)+A(1)+L(1)

[symbol] 13 strokes in total

As can be seen from the above English letter input example, in the case of inputting the word “INTERNATIONAL”, the conventional method requires 28 button-pressings in total. According to the present invention, however, since each letter is assigned to each button and thus each letter can be input by one stroke, the word can be input in total 13 strokes, which is less than a half of the conventional case, thereby enabling a fast and convenient letter input.

FIG. 5 explains a character-input method according to another embodiment of the invention. In this embodiment, the principle of previous embodiments is further expanded, in which more letters can be easily input through a less number of buttons and a less number of strokes.

In this embodiment, the principles of the invention for inputting letters will be specifically explained, referring to four buttons among many buttons. The remaining buttons employs the same method and principles as in the following explanation. The letters may include Japanese, French, Russian letters and the like, along with English letter. Thus, the present embodiment will be explained, replacing the letter assigned to each button with a number. In addition, the numbers 1, 3, 5 and 7 assigned to the first position of each button denotes a button number.

The number 1, 3, 5 or 7 assigned to the first position of each button is input through a single click of each corresponding button, and the number 2, 4, 6 or 8 assigned to the second position of each button is input through a double-click of each corresponding button. The numbers 9, 10, 11 and 12 assigned to between the buttons in horizontal direction are configured to be input through an overlapped-pressing or a long-and-short continuous pressing of the two buttons. This combination pressing is preformed in the same manner as above described. In this embodiment, however, two letters are assigned to between two buttons and one of the assigned two letter is selectively input according to the pressing order of the two buttons. Thus, in this embodiment, the simultaneous pressing is avoided, and the overlapped-pressing or the long-and-short continuous pressing involving a pressing order is employed. For example, in the first row, the numbers 9 and 10 are assigned to between the number one button and the number three button. At this time, the number 9 can be input by pressing the number three button with the number one button pressed, or by pressing two buttons in sequence where one of them is pressed longer and the other is pressed shorter, i.e., by a long-and-short continuous pressing. The number 10 can be input in the reverse order to the case of inputting the number 9, i.e., by pressing the number three button and then the number one button. Of course, pressing the number three button inputs a letter corresponding to that button and pressing the number one button inputs a letter assigned to that button. Thus, in this embodiment, the sequential pressing denotes an overlapped-pressing or a long-and-short continuous pressing.

In the case of the numbers 13, 14, 15 and 16 vertically assigned to between the buttons, the same input principles as above is applied. For example, in the first column, the numbers 13 and 14 are assigned to between the number one button and the number five button. The number 13 is input by pressing the number one button first and then the number five button, and the number 14 is input by pressing the number five button first and then the number one button. Here, the sequential pressing mode means an overlapped-pressing or a long-and-short continuous pressing.

The letters assigned to between two diagonal buttons, i.e., the numbers 17, 18, 19 and 20 in the figure are input through sequential pressings of the two buttons according to the same inputting principles as in the horizontally or vertically assigned letters. Thus, details thereon will not be repeated here.

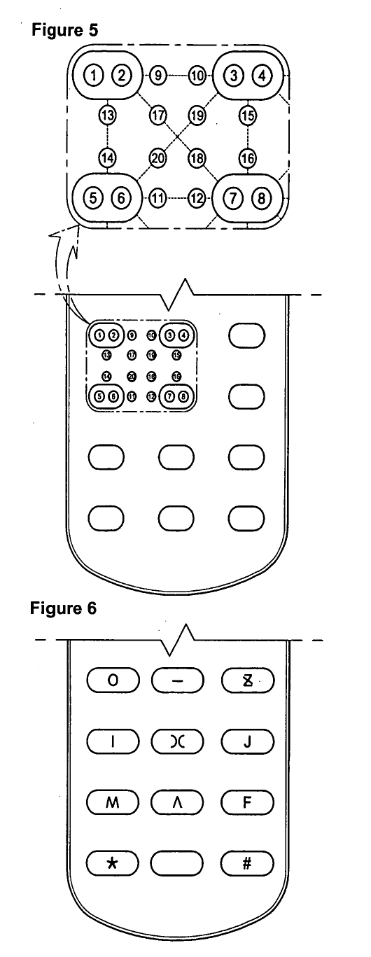

FIG. 6 shows an arrangement of buttons for inputting English letters according to another embodiment of the invention.

In this embodiment of English letter input method, all the alphabets are analyzed to generate basic letter. These basic letters are combined to construct all the alphabets. As the basic letters, nine characters 0, −, [symbol] , I, [symbol] , J, M, ˆ, and F are selected, considering the letter generation principle and input frequencies thereof. These nine characters are assigned to the respective buttons one by one. In particular, relevant letters are adjacently assigned for easy visual association when in letter combinations. For example, the alphabet ‘P’ is associative of ‘O’+‘l’ and thus the letter ‘O’ and ‘I’ are vertically assigned to the number one button and the number four button respectively, thereby enabling easy association of combination for ‘P’. The alphabet ‘Q’ is associative of ‘O’+‘−’ and thus ‘−’ is assigned adjacently to the right of ‘Q’, thereby providing an easy visual association. In case of the alphabet ‘D’, ‘ [symbol] ’ is assigned adjacently to the right of ‘I’ such that the left half of ‘ [symbol] ’ can be associative of “D”. The alphabet ‘G’ is assigned such that the right half of ‘ [symbol] ’ and the ‘J’ assigned adjacently to the right of ‘ [symbol] ’ can be associatively combined. In summary, as illustrated in FIG. 6, the above basic letters are assigned respectively to the number one to nine buttons, preferably in such a manner that the characters ‘O’, ‘−’, ‘ [symbol] ’, ‘I’, ‘ [symbol] ’, ‘J’, ‘M’, ‘ˆ’, and ‘F’ are assigned to the number one to nine buttons in the described order.

As described above, all the alphabets can be formed through combinations of the basic letters assigned to each button, with the basic letter remained as they are, rotated at 90-degrees, or in vertically or horizontally symmetrical state. Based on this combination principle, two corresponding buttons are combined and pressed to input the combined alphabet. The principles for the above-described alphabet combination are summarized in the following table 2.

TABLE 2
Combination principle of alphabets

| Alphabets | Combinations | Buttons |
|---|---|---|
| A | Λ | 8 |
| B | I + M(90°-rotation) [symbol] [symbol] | 4 + 7 |
| C | [symbol] (selection of right side) | 5 |
| D | I + [symbol] (selection of left side) [symbol] ^{D} | 4 + 5 |
| E | F + _{—} | 9 + 2 |
| F | F | 9 |
| G | [symbol] (selection of right side) + J [symbol] ^{C}J | 5 + 6 |
| H | I double-click | 4 + 4 |
| I | I | 4 |
| J | J | 6 |
| K | I + Λ (90°-rotation) [symbol] κ | 4 + 8 |
| L | I + _{—} | 4 +2 |
| M | M | 7 |
| N | Λ + I | 8 + 4 |
| O | O | 1 |
| P | O + I [symbol] ρ | 1 + 4 |
| Q | O + _{—} | 1 + 2 |
| R | O + Λ [symbol] [symbol] | 1 + 8 |
| S | [symbol] double-click | 5 |
| T | - + I | 2 + 4 |
| U | I + J | 4 + 6 |
| V | Λ double-click | 8 |
| W | M double-click | 7 |
| X | [symbol] | 3 |
| Y | Λ (vertical symmetry) + _(90°-rotation) [symbol] γ | 8 + 2 |
| Z | [symbol] double-click | 3 |

In this method, a combination of pressing order is applied, i.e., the combination is performed through an overlapped pressing or a long-and-short continuous pressing. Furthermore, this method employs a concept of double-click.

As can be seen from the above table 2, according to this method of inputting English letters, A, C, F, I, J, M, O, and X are input by pressing the respective button once, H, S, V, W, and Z are input through a double-click of the corresponding button, and the remaining letters B, D, E, G, K, L, N, P, Q, R, T, U and Y are input through an overlapped-pressing or a long-and-short continuous pressing of two button according to the order explained in the table 2. Here, the present method is further explained, comparing with conventional one, through the following input example.

### EXAMPLE 3 OF ENGLISH LETTER INPUT

The English letter input method of this embodiment is compared with a conventional method described previously in conjunction with FIG. 1, through inputting the following sentence using cellular phone buttons.

In a case of inputting a sentence “CELLULAR PHONE IS A BLACK HOLE OF ALL THE FUNCTIONS OF MOBILE UTILITIES.”, the input strokes can be compared as follows, for the input method of the invention and the conventional one.

1. In Case of a Conventional Method

‘C(3)+E(2)+L(3)+L(3)+U(2)+L(3)+A(1)+R(2)’+‘P(1)+H(2)+O(3)+N(2)+E(2)’+‘I(3)+S(3)’+‘A(1)’+‘B(2)+L(3)+A(1)+C(3)+K(2)’+‘H (2)+O(3)+L(3)+E(2)’+‘O(3)+F(3)’+‘A(1)+L(3)+L(3)’+‘T(1)+H(2)+E(2)’+‘F(3)+U(2)+N(2)+C(3)+T(1)+I(3)+O(3)+N(2)+S(3)’+‘O(3)+F(3)’+‘M(1)+O(3)+B(2)+I(3)+L(3)+E(2)’+‘U(2)+T(1)+I(3)+L(3)+I(3)+T(1)+I(3)+E(2)+S(3)’

[symbol] 138 (letter input)+7 (fixing button)=145 strokes in total

2. In a Case of the Present Invention

A long-and-short continuous pressings (counted as two strokes)

‘C(2)+E(2)+L(2)+L(2)+U(2)+L(2)+A(1)+R(2)’+‘P(2)+H(2)+O(1)+N(2)+E(2)’+‘I(1)+S(1)’+‘A(1)’+‘B(2)+L(2)+A(1)+C(2)+K(2)’+‘H(2)+O(1)+L(2)+E(2)’+‘O(1)+F(1)’+‘A(1)+L(2)+L(2)’+‘T(2)+H(2)+E(2)’+‘F(1)+U(2)+N(2)+C(1)+T(2)+I(1)+O(1)+N(2)+S(1)’+‘O(1)+F(1)’+‘M(1)+O(1)+B(2)+I(1)+L(2)+E(2)’+‘U(2)+T(2)+I(1)+L(2)+I(1)+T(2)+I(1)+E(2)+S(1)’

[symbol] 92 strokes in total

Overlapped-pressing (counted as one stroke)

‘C(1)+E(1)+L(1)+L(1)+U(1)+L(1)+A(1)+R(1)’+‘P(1)+H(1)+O(1)+N(1)+E(1)’+‘I(1)+S(1)’+‘A(1)’+‘B(1)+L(1)+A(1)+C(1)+K(1)’+‘H(1)+O(1)+L(1)+E(1)’+‘O(1)+F(1)’+‘A(1)+L(1)+L(1)’+‘T(1)+H(1)+E(1)’+‘F(1)+U(1)+N(1)+C(1)+T(1)+I(1)+O(1)+N(1)+S(1)’+‘O(1)+F(1)’+‘M(1)+O(1)+B(1)+I(1)+L(1)+E(1)’+‘U(1)+T(1)+I(1)+L(1)+I(1)+T(1)+I(1)+E(1)+S(1)’

[symbol] 59 strokes in total

As can be seen in the above letter input example three, as many as 145 strokes are required in case of the conventional input method. In contrast, according to the present invention, only 92 strokes are needed in the case of the long-and-short continuous pressing mode. In the case of the simultaneous pressing, only 59 strokes are required for inputting the same sentence.

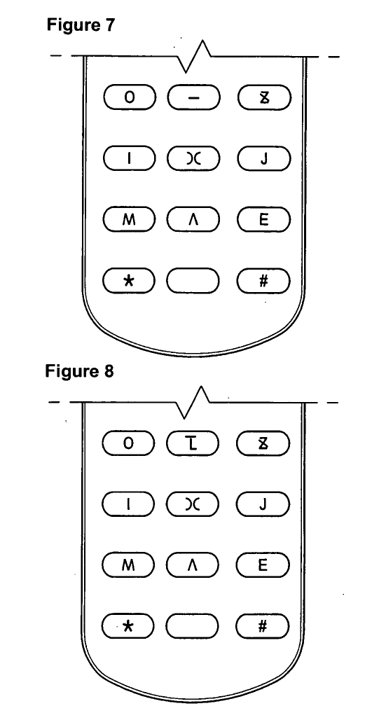

FIGS. 7 and 8 shows modifications of FIG. 6. In FIG. 7, the number nine button of FIG. 6 is assigned with ‘E’ having a higher frequency of use, instead of ‘F’, thereby providing an easy input of ‘E’. ‘F’ is input by pressing the number two button (−) twice continuously with the number four button (I) pressed, in the case of an overlapped mode. The remaining alphabets are input in the same manner as in FIG. 6. On the other hand, in the case where a simultaneous pressing mode is applied, ‘T’ (‘−’+‘I’) and ‘L’ (‘I’+‘−’) employ a long-and-short continuous pressing mode having an order, and ‘F’ is input by pressing ‘I’ and ‘−’ simultaneously. Thus, as compared with the above overlapped mode, twice pressing of ‘−’ can be avoided.

On the other hand, in FIG. 8, the number two button assigned with ‘−’ of FIG. 7 is assigned with ‘TL’ together and expressed by ‘I’ on the button, such that one pressing of the number two button inputs ‘T’ and a double-click thereof inputs ‘L’. At this time, ‘−’ is not able to be independently input, but functions as ‘−’ only when combined with a button assigned with other basic letters. In other words, since ‘L’ is input by a double-click, ‘F’ is input through a simultaneous pressing, an overlapped sequential pressing or a long-and-short continuous pressing of the number four button (I) and the number two button (−). Of course, the remaining alphabets in FIG. 8 are input according to the same combination principles as in FIG. 7.

### INDUSTRIAL APPLICABILITY

As apparent from the above description, the character-input mechanism of the present invention can be implemented through a program to be installed in electronic devices. Therefore, only the program can be replaced from existing electronic devices having character-input buttons, thereby easily and conveniently applying the method of the invention to the existing products.

Although the present invention has been described with reference to several preferred embodiments, the description is illustrative of the invention and not to be construed as limiting the invention. Various modifications and variations may occur to those skilled in the art, without departing from the scope and spirit of the invention as defined by the appended claims.

1. A method of inputting a character in an electronic device having a character input button, wherein a character is assigned to each button of a keypad of the electronic device, and at least one character is assigned to between neighboring two buttons such that the neighboring two buttons are simultaneously pressed, overlapped-pressed, or continuously pressed in a longer and shorter pattern to input the at least one character assigned in-between.

2. The method as claimed in claim 1, wherein the neighboring two buttons are adjacent to each other in horizontal, vertical or diagonal direction, and the respective neighboring two buttons are assigned with a character, wherein the assigned character is input by the simultaneous pressing, the overlapped-pressing, or the long-and-short continuous pressing.

3. The method as claimed in claim 1, wherein the neighboring two buttons are adjacent to each other in horizontal, vertical or diagonal direction, and the respective neighboring two buttons are assigned with two characters, wherein the assigned characters is selectively input by the pressing order of the two buttons through the overlapped-pressing, or the long-and-short continuous pressing.

4. The method as claimed in claim 3, wherein each of the buttons is assigned with two characters respectively in a first position and in a second position, wherein one of the two character is input by one pressing of each corresponding button and the other one thereof is input by a double pressing of the same corresponding button.

5. A method of inputting English letters in an electronic device having a character input button arranged in rows and columns, wherein English letters ‘T’, ‘I’, ‘N’, ‘A’, ‘E’, ‘R’, ‘S’, ‘O’, and ‘L’ are assigned to nine buttons respectively, the remaining letters are assigned to between two neighboring buttons in horizontal, vertical and diagonal directions, such that the simultaneous pressing, the overlapped-pressing, or the long-and-short continuous pressing of the two neighboring buttons inputs the corresponding letter assigned in-between.

6. The method as claimed in claim 5, wherein the buttons are arranged in four rows and three columns where six letters are assigned, in total, to between two buttons horizontally adjacent in three buttons in each row, letters are assigned to between vertically adjacent in four buttons in each column, and letters are assigned to between two buttons diagonally adjacent, thereby assigning the remaining letters.

7. The method as claimed in claim 6, wherein the electronic device includes a cellular phone, and the letter ‘T’, ‘I’, ‘N’, ‘A’, ‘E’, ‘R’, ‘S’, ‘O’, and ‘L’ are assigned to the number one to nine buttons in the described order.

8. The method as claimed in claim 7, wherein the buttons in each column are arranged in zigzags such that interference between two fingers can be minimized when in the simultaneous pressing or the overlapped-pressing.

9. The method as claimed in claim 6, wherein a symbol is assigned to beyond the second position of each button such that the symbol can be input by a double click in a cyclic fashion.

10. A method of inputting English letters in an electronic device having a character input button arranged in rows and columns, wherein nine basic letters 0, −, [symbol] , I, [symbol] , J, M, ˆ, and E are assigned to the respective buttons, letters O, X, I, C, J, M, A, and E are input by pressing each button once, and the remaining letters are input through an overlapped-pressing or a long-and-short continuous pressing of two buttons assigned with the basic letters, or through a double-click of one button.

11. The method as claimed in claim 10, wherein the remaining letters are input through the overlapped-pressing or the long-and-short continuous pressing of the two buttons and the double-click in the combination of the following table.

| Letters | Combinations |
|---|---|
| B | I + M |
| D | I + [symbol] |
| F | I + - + - (overlapped) |
| G | [symbol] + J |
| H | I double-click |
| K | I + Λ (90°-rotation) |
| L | I + _{—} |
| N | Λ + I |
| P | O + I |
| Q | O + _{—} |
| R | O + Λ |
| S | [symbol] double-click |
| T | - + I |
| U | I + J |
| V | Λ double click |
| W | M double click |
| Y | Λ (vertical symmetry) + |
| | _(90°-rotation) |
| Z | [symbol] double-click |

12. The method as claimed in claim 10, wherein the above basic letter ‘−’ is not able to be input independently, but functions only when combination input of two buttons, and a button assigned with the basic letter ‘−’ is assigned with ‘TL’ together and expressed with ‘I’, wherein the alphabet ‘T’ is input by a single pressing, the alphabet ‘L’ is input by a double-click, and the button of ‘−’ functions as ‘−’ when the ‘−’ is combined with other buttons assigned with the basic letters.

13. The method as claimed in claim 11, wherein the electronic device includes a cellular phone, and the basic nine letters 0, −, [symbol] , I, [symbol] , J, M, ˆ, and E are assigned to the number one to nine buttons of the cellular phone in the described order.

14. The method as claimed in claim 10, wherein a second position or a third position of each button is assigned with symbols such that the assigned symbols are input by a double-click in a cyclic fashion.

15. A method of inputting English letters in an electronic device having a character input button arranged in rows and columns, wherein nine basic letters 0, −, [symbol] , I, [symbol] , J, M, ˆ, and F are assigned to the respective buttons, letters O, X, I, C, J, M, A, and F are input by pressing each button once, and the remaining letters are input through an overlapped-pressing or a long-and-short continuous pressing of two buttons assigned with the basic letters, or through a double-click of one button.

16. The method as claimed in claim 15, wherein the remaining alphabet letters are input through the overlapped-pressing or the long-and-short continuous pressing of the two buttons, or through the double-click of one button in the combinations of the following table.

| Letters | Combinations |
|---|---|
| B | I + M (90°-rotation) |
| D | I + [symbol] |
| E | F + - (Overlapped) |
| G | [symbol] + J |
| H | I Double-click |
| K | I + Λ (90°-rotation) |
| L | I + _{—} |
| N | Λ + I |
| P | O + I |
| Q | O + _{—} |
| R | O + Λ |
| S | [symbol] Double-click |
| T | - + I |
| U | I + J |
| V | Λ Double-click |
| W | M Double-click |
| Y | Λ (Vertical symmetry) + |
| | _(90°-rotation) |
| Z | [symbol] Double-click |

17. The method as claimed in claim 15, wherein a second position or a third position of each button is assigned with symbols such that the assigned symbols are input by a double-click in a cyclic fashion.

18. The method as claimed in claim 16, wherein the electronic device includes a cellular phone, and the basic nine letters 0, −, [symbol] , I, [symbol] , J, M, ˆ, and F are assigned to the number one to nine buttons of the cellular phone in the described order.
